(19) United States
(12) Patent Application Publication
(10) Pub. No.: US 2002/0077831 A1
(43) Pub. Date: Jun. 20, 2002

(54) Data input/output method and system without being notified

(76) Inventor: Takayuki Numa, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 09/994,795

(22) Filed: Nov. 28, 2001

(30) Foreign Application Priority Data
Nov. 28, 2000 (JP) 2000-361356

(51) Int. Cl. G10L 21/00; G10L 15/00

(52) U.S. Cl. 704/275

(57) ABSTRACT

An input method and device allowing a user to operate a computer without being notified is disclosed. A bone conduction microphone is used to pick up a sound produced in an oral cavity of a user. A plurality of registered sounds is previously registered in a database. Each registered sound corresponds to a different computer instruction. When inputting an input sound through the bone conduction microphone, the database is searched for an instruction corresponding to the input sound and the instruction to operate the computer is determined.

### BACKGROUND OF THE INVENTION

1. Field of the Invention

The present invention relates to a data processing system using bone conduction technology, and in particular to operation data input/output method and system for the data processing system.

2. Description of the Related Art

There have been proposed various data processing systems using the bone conduction technology. In Japanese Patent Application Unexamined Publication No. 10-228367, for example, a data transmission terminal is connected to a bone conduction microphone and further to a server. The bone conduction microphone is mounted in the operator's ear and picks up voice data to output it to the data transmission terminal. The data transmission terminal has a voice recognition function and recognizes predetermined words from input voice data. In this manner, the operator can operate the data transmission terminal by voice control without touching it. Contrarily, the operator is notified of various instructions from the data transmission terminal through the earphone mounted in the operator's ear.

In such prior art, however, voice recognition requires the operator's voice or vibrations caused by voice. Silent operation or notification is impossible. Accordingly, for example, when a person is implicated in a crime, the person cannot inform the police of the case and its whereabouts in front of the criminal. Further, when the person is bound hand and foot or gagged by the criminal, it is difficult to operate a computer to inform to the police without being notified.

In Japanese Patent Application Unexamined Publication No. 9-54819, sounds generated in the oral cavity of a user are picked up by a bone conduction microphone and the chewing sound component is extracted from the sounds. By count the number of times the chewing sound component is extracted, it can be determined how many times the user has chewed. However, this prior art has no motivation for operating a computer or the like without being notified.

### SUMMARY OF THE INVENTION

An object of the present invention is to provide an input method and a data processing system allowing a user to operate a computer and the like without using voices.

Another object of the present invention is to provide a data processing system allowing a user to inform a desired destination without being notified by other persons.

According to the present invention, a method for inputting an instruction to operate a computer, using a bone conduction microphone for picking up a sound produced in an oral cavity of a user, includes the steps of: a) retrievably storing a plurality of registered sounds in a memory, each of the registered sounds corresponding to a different instruction; b) inputting an input sound through the bone conduction microphone; c) searching the memory for an instruction using the input sound as a key; and d) determining the instruction to operate the computer.

Each of the registered sounds stored in the memory may be determined by at least one predetermined unit sound which is allowed to be produced in the oral cavity of the user. Each of the registered sounds stored in the memory may be determined by a combination of said at least one predetermined unit sound produced for a predetermined time period after a first unit sound has been produced. According to an example, each of the registered sounds is produced by one of teeth-clicking and tongue-moving.

The step d) may include the steps of: d.1) chocking for the instruction through a bone conduction speaker; and d.2) when receiving no negative response through the bone conduction microphone, finally determining the instruction to operate the computer.

The computer may have a calling function of making a call, wherein the instruction to the computer is to make a call to a predetermined destination.

According to another aspect of the present invention, a system for determining an instruction to operate a computer, includes: a bone conduction microphone for picking up a sound produced in an oral cavity of a user, wherein the bone conduction microphone is mounted on a head of a user; a database for retrievably storing a plurality of registered sounds, each of the registered sounds corresponding to a different instruction; a processor controlling such that, when inputting an input sound through the bone conduction microphone, the database is searched for an instruction corresponding to the input sound and, when the instruction is found, an operation corresponding to the instruction is performed.

A memory storing a plurality of programs may be further included, wherein the processor selects one of the programs depending on the instruction and executes the selected program.

The system may further include a communication section for making a call, wherein the programs includes a telephone-calling program including a predetermined message, wherein the telephone-calling program is selected by the processor to make a call to send the predetermined message to a predetermined destination depending on the instruction.

The system may further include a GPS receiver for receiving GPS signals to obtain geographical location information, wherein the predetermined message with the geographical location information is sent to the predetermined destination.

According to an embodiment of the present invention, a system includes an input/output device and a main processing device, which are provided separately from each other. The input/output device includes: a bone conduction microphone for picking up a sound produced in an oral cavity of a user, wherein the bone conduction microphone is mounted on a head of a user; and a first wireless communication section for communicating with the main processing device. The main processing device includes: a second wireless communication section for communicating with the input/output device; a database for retrievably storing a plurality of registered sounds, each of the registered sounds corresponding to a different instruction; and a processor controlling such that, when inputting an input sound from the input/output device through the second wireless communication section, the database is searched for an instruction corresponding to the input sound and, when the instruction is found, an operation corresponding to the instruction is performed.

According to another embodiment of the present invention, a system includes an input/output device and a main processing device, which are provided separately from each other. The input/output device includes: a none conduction microphone for picking up a sound produced in an oral cavity of a user, wherein the bone conduction microphone is mounted on a head of a user; a database for retrievably storing a plurality of registered sounds, each of the registered sound corresponding to a different instruction; a first processor controlling such that, when inputting an input sound from the bone conduction microphone, the database is searched for an instruction corresponding to the input sound; and a first wireless communication section for sending the instruction to the main processing device. The main processing device includes: a second wireless communication section for receiving the instruction from the input/output device; and a second processor controlling such that, when inputting the instruction from the input/output device through the second wireless communication section, an operation corresponding to the instruction is performed.

According to still another aspect of the present invention, an input/output device includes: a bone conduction microphone for picking up a sound produced in an oral cavity of a user, wherein the bone conduction microphone is mounted on a head of a user; a database for retrievably storing a plurality of registered sounds, each of the registered sounds corresponding to a different instruction; processor controlling such that, when inputting an input sound from the bone conduction microphone, the database is searched for an instruction corresponding to the input sound, and an interface to an external information processing device, for sending the instruction to the external information processing device.

The input/output device preferably further includes a bone conduction speaker for producing bone conduction vibrations, wherein the bone conduction speaker is mounted on the head of the user, wherein a sound signal received from the external information processing device through the interface is output to the bone conduction speaker which converts it into bone conduction vibrations.

### BRIEF DESCRIPTION OF THE DRAWINGS

FIG. 1 is a block diagram showing a processing system according to a first embodiment of the present invention;

FIG. 2 is a flow chart showing a registration procedure to form a database of the first embodiment;

FIG. 3 is a diagram showing an example of contents registered in the database of the first embodiment;

FIG. 4 is a flow chart showing a data searching operation of the first embodiment;

FIG. 5 is a block diagram showing a processing system according to a second embodiment of the present invention;

FIG. 6 is a schematic diagram showing a case where a user is mounted with the processing system according to the second embodiment; and

FIG. 7 is a block diagram showing a processing system according to a third embodiment of the present invention.

### DESCRIPTION OF THE PREFERRED EMBODIMENTS

### First Embodiment

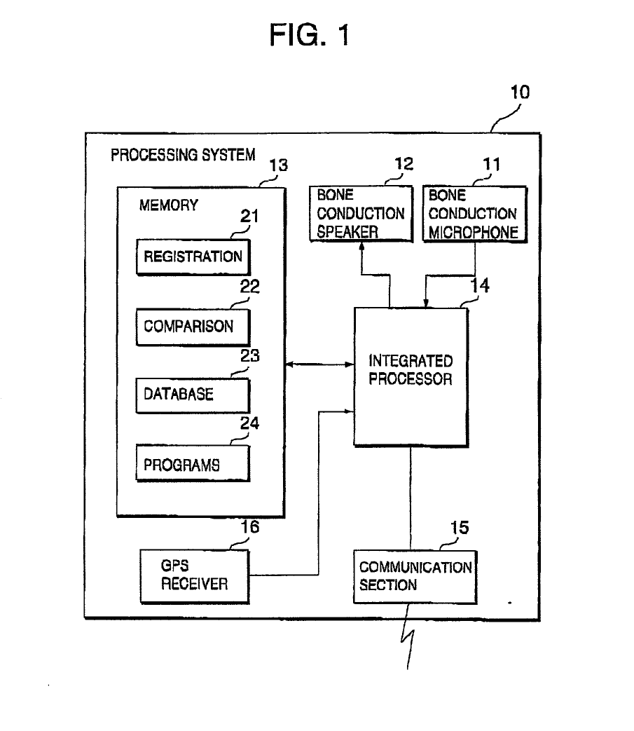

Referring to FIG. 1, a processing system 10 according to a first embodiment of the present invention is designed to be mounted on the head of a user. The processing system 10 is provided with a bone conduction microphone 11 and a bone conduction speaker 12, which come into direct contact with the head. The processing system 10 should be made smaller in size and shaped so as to be discreetly hidden. Preferably, it can be mounted in the ear like an earphone or shaped so as to be hidden in the user's hair. The processing system 10 is further provided with a memory 13, an integrated processor 14, a communication section 15, and a GPS (Global Positioning System) receiver 16.

The bone conduction microphone 11 picks up bone conduction sounds or vibrations generated in the oral cavity of the user to output electric signals to the integrated processor 14. The bone conduction speaker 12 receives electric signals from the integrated processor 14 to convert it into bone conduction vibrations or sounds so as to inform the user. When the processing system 10 is mounted in the ear like an earphone, an ordinary earphone speaker may be used in place of tho bone conduction speaker 12.

The memory 13 stores registration program 21, comparison program 22, database 23, and other programs 24. The integrated processor 14 executes the registration program 21 to perform data registration of the database 23, the comparison program 22 to perform searching the database 23, and other programs 24 to perform predetermined procedures.

In this embodiment, the integrated processor 14 includes a CPU (central processing unit), an input converter for converting an input sound signal from the bone conduction microphone 11 into a digital form to register it into the database 23, and an output converter for converting voice data read out from the database 23 into an analog form to output it to the bone conduction speaker 12.

The communication section 15 has a function of connecting to a public network such as a mobile telephone network to make a call under control of the integrated processor 14. The GPS receiver 16 receives GPS signals from GPS satellites to obtain its location information, which is output to the integrated processor 14.

### Registration

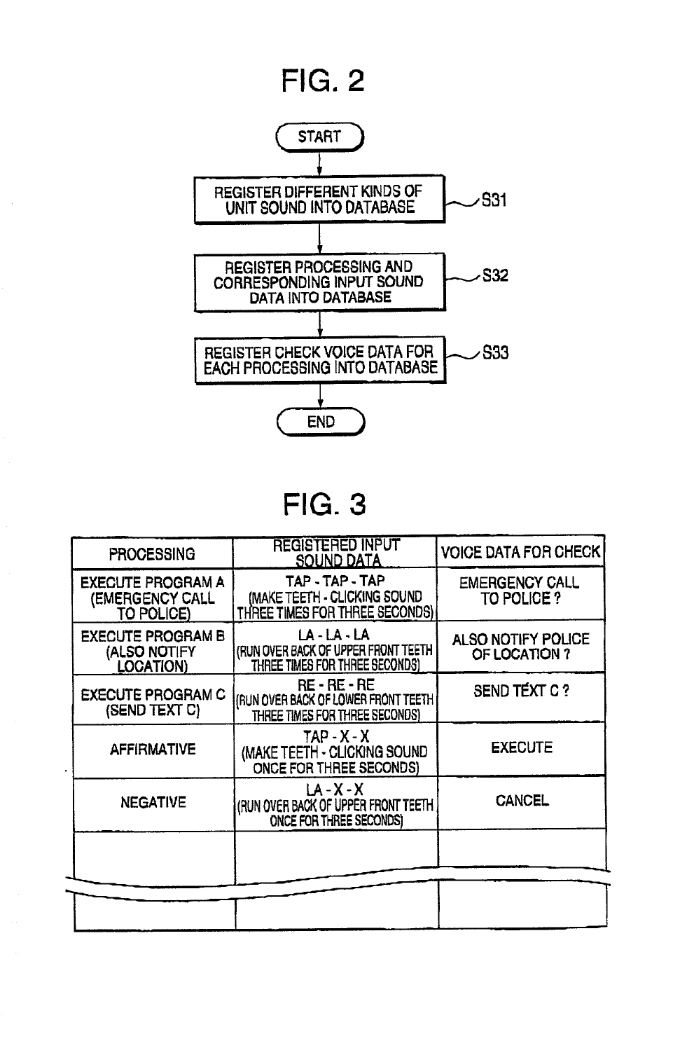

The database registration procedure of input sound data will be described with reference to FIG. 2. Here, an input sound is a sound generated in an oral cavity of a user. The kind of an input sound is defined as a unit sound and desired processing is designated by a combination of unit sounds generated for a predetermined time period. The user can easily register input sounds by executing the registration program which is a registration-support program.

Referring to FIG. 2, first, a necessary number of different kinds of unit sounds are registered into the database 2, (step S31). Different kinds of unit sounds can be generated by teeth-clicking, tongue-running over the back surface of upper front teeth, tongue-running over the back surface of lower front teeth, and so on.

Thereafter, with the help of the registration program 21, the user combines at least one of the registered unit sounds to produce input sound data to be registered for a desired processing content and registers it into the database 23 (stop S32). A processing content is determined by registering the name of a program to be executed for the processing content.

Finally, with the help of the registration program 21, the user registers check voice data which is used to check with the user for a user's instruction designated by the input sound data (step S33).

In FIG. 3, an example of registered data in the database 23 is shown. Here, three unit sounds are used. A first unit sound generated by teeth-clicking is denoted by “tap”, a second unit sound by tongue-running over the back surface of upper front teeth is “La”, and a third unit sound by tongue-running over the back surface of lower front teeth is “Re”. Accordingly, an input sound is defined as a combination and sequence, or permutation, of “tap”, “La”, and “Re” for a predetermined time period (here, three seconds).

As shown in FIG. 3, for example, when the teeth-clicking sound has been made three times for three seconds (“tap-tap-tap”), a program A will be executed to make an emergency call to the police. When the teeth-clicking sound has been made once for three seconds (“tap-x-x”), it means an affirmative response to a check message.

As described later, the programs A, B, C and the like as shown in FIG. 3 are previously registered in the programs 24 of the memory 13.

In the case of the program A, for example, the phone number of the police may be included in the program A. Further, the program A has a function of controlling the communication section 15 to make a call.

In the case of the program B, the phone number of the police may be included in the program B. Further, the program B has a function of controlling the GPS receiver 16 to receive location information and a function of controlling the communication section 15 to make a call.

In this embodiment, the processing system 10 has no input/output operation means during the registration procedure. Accordingly, the registration is performed by coupling the processing system 10 with a detachable input/output device and, after registration has been completed, the detachable input/output device is removed. The integrated processor 14 includes such a function of connection/disconnection of the input/output device.

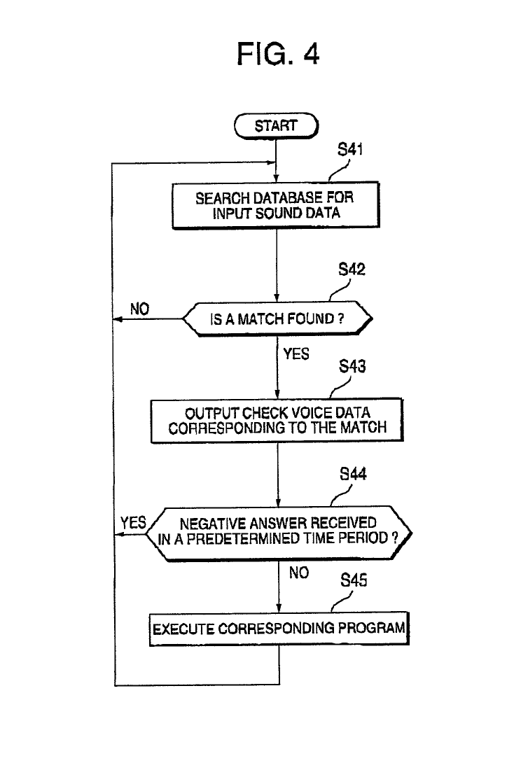

After the registration is completed, the processing system 10 can operate. When the comparison program 22 starts, it is determined what is meant by an input sound. The details will be described with reference to FIG. 4.

### Comparison

Referring to FIG. 4, when a user inputs a sound through the bone conduction microphone 11 as described above, the comparison program 22 searches the database 23 for the input sound data that has been processed by the integrated processor 14 (step S41) and determines whether a match is found (step S42). More specifically, when a sound has bean inputted, the comparison program 22 waits for a following sound for three seconds after the first sound has been inputted. As described before, a combination of at least one unit sound which has been inputted for three seconds is subjected to the comparison procedure (step S41 and S42). Such comparison can be performed using well-known voice recognition technology on a computer. In the case of a small number of kinds of unit sound as shown in FIG. 3, the voice recognition may be realized more simply.

When no match is found (NO in step S42), the control goes back to the step S41 to wait for next sound input. A message such as “NOT RECOGNIZED” may be output through the bone conduction speaker 12 to prompt the user to enter it again.

When a match is found (YES in step S42), the comparison program 22 outputs a check message to the bone conduction speaker 12 (step S43). For example, when the comparison program 22 has recognized the input sound composed or a sequence of three unit sounds “tap-tap-tap”, a check voice message such as “CALL To POLICE?” is output from the bone conduction speaker 12. Then, the comparison program determined whether a negative answer is inputted in a predetermined time period (step S44).

When a negative answer (here, “La-x-x”) has been received (YES in step S44), the control goes back to the step S41 because of erroneous input operation.

When no answer or an affirmative answer (here, “tap-x-x”) has been received (NO in step S44), the integrated processor 14 executes a corresponding program from the programs 24 stored in the memory 13 (step S45). For example, in the case where “tap-tap-tap” has been inputted as input sound data, the program A (Emergency call to Police) starts. When the program A starts, the integrated processor 14 instructs the communication section 15 to make a call to the police at the preset phone number. If case occurrence place, informer's name, and the like are stored, such message and/or a preset Cannot-reply message may be transmitted as voice data to the police.

When the user is forced to move to another place, the user starts the program A by entering “La-La-La” and thereby the location information obtained by the GPS receiver 16 can ba also transmitted to the police, together with the case occurrence place and the informer's name, which results in prompt rescue operation.

As described above, according to the first embodiment, the user can perform a desired operation such as making a call to the police or the like without being notified by other persons (for example, a criminal).

In FIG. 4, the check steps S43 and S44 can prevent the user from erroneous input operation. However, it is possible to omit these check step S43 and S44. In such a case, the bone conduction speaker 12 may be removed because registration of the check voice message is not required.

As another example, pluralities of texts are previously prepared in the memory 13 and a selected text can be transmitted without being notified to a portable information device possessed by another person, for example, by be-mail. This function is useful when the user attends a conference. More specifically, the user starts the program C by entering “Re-Re-Re” and thereby a corresponding text C can be transmitted to a corresponding destination. Plural input sounds may be prepared for texts to be transmitted or destination addresses to allow desired transmission of a desired text to a desired destination. Since a small amount of information can be easily sent to each other without being notified by other attendances in a meeting, it is very useful communication means in some cases.

### Second Embodiment

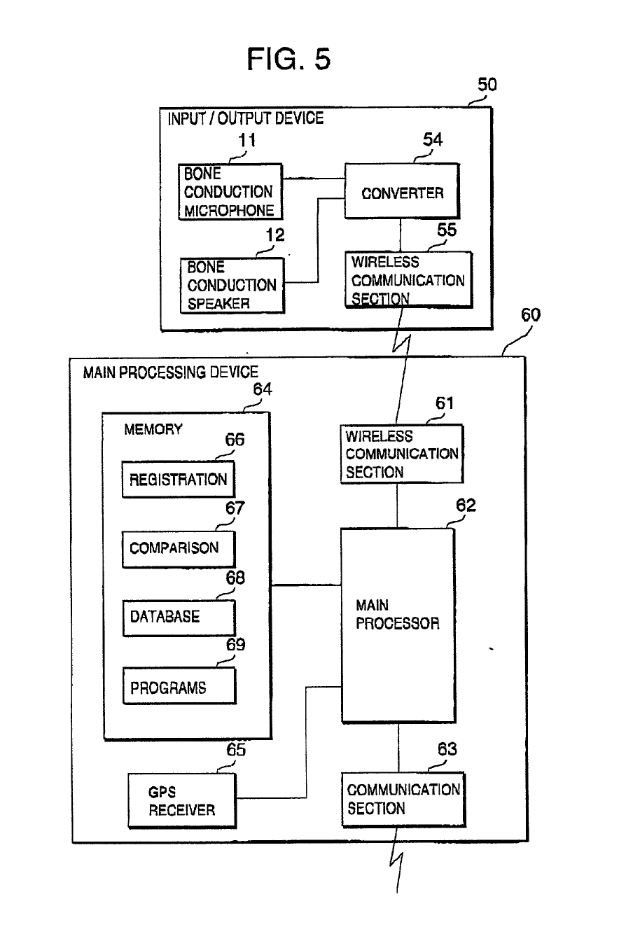

Referring to FIG. 5, a processing system according to a second embodiment of the present invention includes an input/output device 50 to be mounted on the user's head or ear and a main processing device 60 to perform main procedures. The input/output device 50 and the main processing device 60 are separately provided, making the input/output device 50 to be mounted on the user's head or ear smaller in size. In this embodiment, the input/output device 50 can communicate with the main processing device 60 by wireless.

In FIG. 5, the input/output device 50 is provided with the bone conduction microphone 11 and the bone conduction speaker 12, which are the same as in the first embodiment. The input/output device 50 is further provided with a converter 54 and a wireless communication section 55. The converter 54 converts an input sound signal from the bone conduction microphone 11 into a form suitable for the main processing device 60, and converts voice data read out from the main processing device 60 into an analog form to output it to the bone conduction speaker 12. The wireless communication section 55 is used to transmit and receive a wireless signal to and from the main processing device 60.

The main processing device 60 includes a wireless communication section 61 which is used to communicate with the wireless communication section 55 of the input/output device 50, a main processor 62, a communication section 63, a memory 64, and a GPS receiver 65. The communication section 63 and the GPS receiver 65 are the same as the communication section 15 and the GPS receiver 16 of the first embodiment shown in FIG. 1.

The memory 64 stores registration program 66, comparison program 67, database 68, and other programs 69, each of which has the same function as a corresponding one of the registration program 21, comparison program 22, database 23, and other programs 24 of FIG. 1. The main processor 62 includes a CPU and an input/output controller and executes the registration program 66 to perform data registration of the database 68, the comparison program 67 to perform searching the database 68, and other programs 69 to perform other predetermined procedures. The wireless communication section 61, the communication section 63, and the GPS receiver 65 are controlled by the main processor 62.

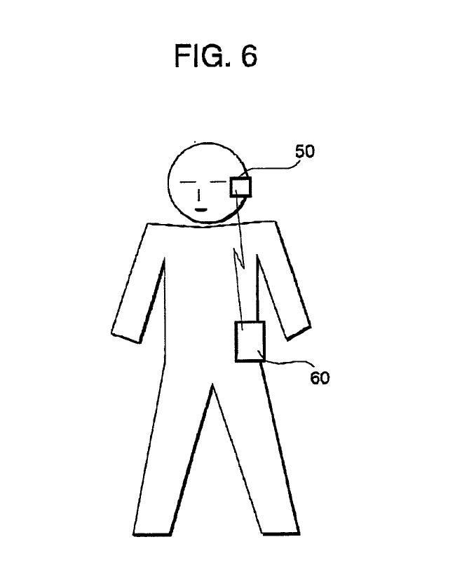

As shown in FIG. 6, the input/output device 50 is mounted on the user's head or ear. The main processing device 60 may be mounted on a discreetly hidden position, for example on the hip or the like. If the main processing device 60 is of wristwatch type, it may be mounted on the user's wrist. In the case where there is no need of sending location information, the main processing device 60 may be fixed on a table.

An operation of the second embodiment as shown in FIG. 5 is the same as that of the first embodiment except that the wireless communication between the input/output device 50 and the main processing device 60 and that the data conversion of the integrated processor 14 is performed by the converter 54 of the input/output device 50. Specifically, the registration program 66 is executed as shown in FIG. 2, and the comparison program 67 is executed as shown in FIG. 4. The database 68 stores data as shown in FIG. 3. Accordingly, descriptions of the operation of the second embodiment are omitted.

According to the second embodiment, the input/output device 50 and the main processing device 60 are separately provided. Therefore, the input/output device 50 to be mounted on the user's head or ear can be made smaller in size, which causes other persons to be more hardly notified.

When the main processing device 60 is provided with a small-sized input/output operation, the registration can be performed without coupled to a detachable input/output device. Accordingly, there is no need of an external input/output device.

### Third Embodiment

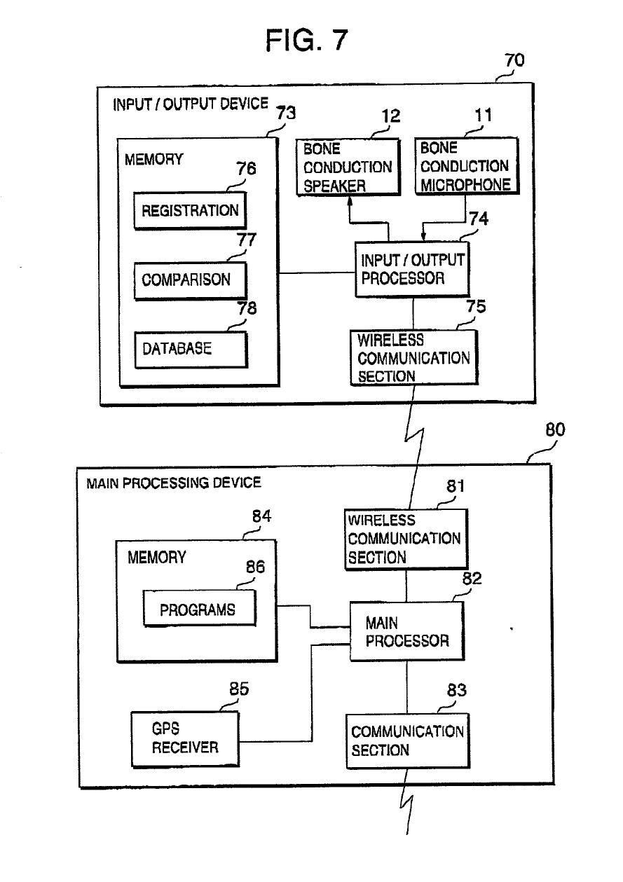

Referring to FIG. 7, a processing system according to a third embodiment is a modification of the second embodiment. The processing system according to the third embodiment includes an input/output device 70 to be mounted on the user's head or ear and a main processing device 80 to perform main procedures. The input/output device 70 and the main processing device 80 are separately provided, which can communicate with each other by wireless.

The input/output device 70, as shown in FIG. 6, is mounted on the user's head or ear. The main processing device 80 may be mounted on a discreetly hidden position, for example on the hip or the like. If the main processing device 80 is of wristwatch type, it may be mounted on the user's wrist. In the case where there is no need of sending location information, the main processing device 80 may be fixed on a table.

In FIG. 7, the input/output device 70 is provided with the bone conduction microphone 11 and the bone conduction speaker 12, which are the same as in the first embodiment. The input/output device 70 is further provided with a memory 73, an input/output processor 74, and a wireless communication section 75.

The memory 73 stores registration program 76, comparison program 77, and database 78, each of which has the same function as a corresponding one of the registration program 21, comparison program 22, and database 23 of FIG. 1. The input/output processor 74 includes a CPU and an input/output controller and executes the registration program 76 to perform data registration of the database 78, and the comparison program 77 to perform searching the database 78. In other words, in the processing system according to the third embodiment, the registration program 76, the comparison program 77, and the database 78 are installed in the input/output device 70. Accordingly, the input/output device 70 is designed to be suitable for connecting to an ordinary information device instead of the main processing device 80.

The bone conduction microphone 11, the bone conduction speaker 12, and the wireless communication section 75 are controlled by the input/output processor 74 as in the case of the second embodiment.

The main processing device 80 includes a wireless communication section 81, a main processor 82, a communication section 83, a memory 84 storing programs 86, and a GPS receiver 85, which are basically the same as those of the second embodiment of FIG. 5. In the third embodiment, since the comparison is performed in the input/output device 70, the main processing device 80 performs programs (programs A, B, C of FIG. 3) after receiving a program name to be executed from the input/output device 70 through the wireless communication section 81.

In this embodiment, the registration may be performed by coupling the main processing device 80 with a detachable input/output device. Alternatively, when the main processing device 80 is provided with a small-sized input/output operation, the registration can be performed without coupled to a detachable input/output device.

As described above, since the sound input/output and the comparison are performed in the input/output device 70, the input/output device 70 is used easily as a separate input/output means.

More specifically, by changing interface, the input/output device 70 can be easily connected to an ordinary information device, which means that it can be put into commercial production. For example, when the input/output device 70 is provided with a standard interface, it can be also used as an input/output device for an ordinary information device such as a personal computer.

The input/output device according to the present invention has an advantage that a person with disability of operating a keyboard or the like or with speech impediment can operate a computer.

1. A method for inputting an instruction to operate a computer, using a bone conduction microphone for picking up a sound produced in an oral cavity of a user, comprising the steps of:
a) retrievably storing a plurality of registered sounds in a memory, each of the registered sounds corresponding to a different instruction;
b) inputting an input sound through the bone conduction microphone;
c) searching the memory for an instruction using the input sound as a key; and
d) determining the instruction to operate the computer.

2. The method according to claim 1, wherein each of the registered sounds stored in the memory is determined by at least one predetermined unit sound which is allowed to be produced in the oral cavity of the user.

3. The method according to claim 2, wherein each of the registered sounds stored in the memory is determined by a combination of said at least one predetermined unit sound produced for a predetermined time period after a first unit sound has been produced.

4. The method according to claim 2, wherein each of the registered sounds is produced by one of teeth-clicking and tongue-moving.

5. The method according to claim 1, wherein the step d) comprises the steps of:
d.1) checking for the instruction through a bone conduction speaker; and
d. 2) when receiving no negative response through the bone conduction microphone, finally determining the instruction to operate the computer.

6. The method according to claim 1, wherein the computer has a calling function of making a call, wherein the instruction to the computer is to make a call to a predetermined destination.

7. A system for determining an instruction to operate a computer, comprising:
a bone microphone for picking up a sound produced in an oral cavity of a user, wherein the bone conduction microphone is mounted on a head of a user;
a database for retrievably storing a plurality of registered sounds, each of the registered sounds corresponding to a different instruction;
processor controlling such that, when inputting an input sound through the bone conduction microphone, the database is searched for an instruction corresponding to the input sound and, when the instruction is found, an operation corresponding to the instruction is performed.

8. The system according to claim 7, further comprising:
a bone conduction speaker for producing bone conduction vibrations, wherein the bone conduction speaker is mounted on the head of the user,
wherein the processor outputs a check signal to the bone conduction speaker to check with the user for the instruction and, when receiving no negative response through the bone conduction microphone, the instruction is finally determined.

9. The system according to claim 7, further comprising:
a communication section for making a call,
wherein the processor instructs the communication section to make a call to a predetermined destination.

10. The system according to claim 7, further comprising:
a memory storing a plurality of programs,
wherein the processor selects one of the programs depending on the instruction and executes the selected program.

11. The system according to claim 10, further comprising:
a communication section for making a call,
wherein the programs includes a telephone-calling program including a predetermined message, wherein the telephone-calling program is selected by the processor to make a call to send the predetermined message to a predetermined destination depending on the instruction.

12. The system according to claim 11, further comprising:
a GPS receiver for receiving GPS signals to obtain geographical location information,
wherein the predetermined message with the geographical location information is sent to the predetermined destination.

13. A system comprising an input/output device and a main processing device, which are provided separately from each other, wherein
the input/output device comprises:
a bone conduction microphone for picking up a sound produced in an oral cavity of a user, wherein the bone conduction microphone is mounted on a head of a user; and
a first wireless communication section for communicating with the main processing device, and
the main processing device comprises:
a second wireless communication section for communicating with the input/output device;
a database for retrievably storing a plurality of registered sounds, each of the registered sounds corresponding to a different instruction; and
a processor controlling such that, when inputting an input sound from the input/output device through the second wireless communication section, the database is searched for an instruction corresponding to the input sound and, when the instruction is found, an operation corresponding to the instruction is performed.

14. A system comprising an input/output device and a main processing device, which are provided separately from each other, wherein
the input/output device comprises:
a bone conduction microphone for picking up a sound produced in an oral cavity of a user, wherein the bone conduction microphone is mounted on a head of a user;
a database for retrievably storing a plurality of registered sounds, each of the registered sounds corresponding to a different instruction; and
a first processor controlling such that, when inputting an input sound from the bone conduction microphone, the database is searched for an instruction corresponding to the input sound; and
a first wireless communication section for sending the instruction to the main processing device, and
the main processing device comprises:
a second wireless communication section for receiving the instruction from the input/output device; and
a second processor controlling such that, when inputting the instruction from the input/output device through the second wireless communication section, an operation corresponding to the instruction is performed.

15. The system according to claim 13, wherein the main processing device further comprises:
a memory storing a plurality of programs including a telephone-calling program having a predetermined message therein; and
a communication section for making a call using a public network,
wherein the telephone-calling program is selected by the processor to make a call to send the predetermined message to a predetermined destination depending on the instruction.

16. The system according to claim 14, wherein the main processing device further comprises:
a memory storing a plurality of programs including a telephone-calling program having a predetermined message therein; and
a communication section for making a call using a public network,
wherein the telephone-calling program is selected by the second processor to make a call to send the predetermined message to a predetermined destination depending on the instruction.

17. The system according to claim 15, wherein the main processing device further comprises:
a GPS receiver for receiving GPS signals to obtain geographical location information,
wherein the predetermined message with the geographical location information is sent to the predetermined destination.

18. The system according to claim 16, wherein the main processing device further comprises:
a GPS receiver for receiving GPS signals to obtain geographical location information,
wherein the predetermined message with the geographical location information is sent to the predetermined destination.

19. An input/output device comprising:
a bone conduction microphone for picking up a sound produced in an oral cavity of a user, wherein the bone conduction microphone is mounted on a head of a user;
a database for retrievably storing a plurality of registered sounds, each of the registered sounds corresponding to a different instruction;
a processor controlling such that, when inputting an input sound from the bone conduction microphone, the database is searched for an instruction corresponding to the input sound; and
an interface to an external information processing device, for sending the instruction to the external information processing device.

20. The input/output device according to claim 19, further comprising:
a bone conduction speaker for producing bone conduction vibrations, wherein the bone conduction speaker is mounted on the head of the user,
wherein a sound signal received from the external information processing device through the interface is output to the bone conduction speaker which converts it into bone conduction vibrations.
